(19) United States
(12) Patent Application Publication
(10) Pub. No.: US 2026/0181063 A1
(43) Pub. Date: Jun. 25, 2026

(54) DEVICE AND METHOD FOR MEDIA UNITS DETECTION IN MOBILE NETWORKS

(71) Applicant: HUAWEI TECHNOLOGIES CO., LTD., Shenzhen (CN)

(72) Inventors: Susanna Schwarzmann, Munich (DE); Qing Wei, Munich (DE)

(73) Assignee: HUAWEI TECHNOLOGIES CO., LTD., Shenzhen (CN)

(21) Appl. No.: 19/535,155

(22) Filed: Feb. 10, 2026

Related U.S. Application Data
(63) Continuation of application No. PCT/EP2023/072198, filed on Aug. 10, 2023.

(51) Int. Cl. H04L 69/324; H04L 43/0829

(52) U.S. Cl. CPC H04L 69/324; H04L 43/0829

(57) ABSTRACT

A network entity for media unit (MU) information detection of a packet in a flow includes at least one processor. The flow includes a plurality of packet sets, and each packet set carries an MU that requires the same treatment in the network. The at least one processor of the network entity obtains at least one of application-level information of the flow, and ground-truth MU information of the packet, where the application-level information of the flow has information regarding an application-specific setting and/or a network-specific setting related to the flow. One or more MU detection criteria are generated for the flow based on the at least one of the application-level information of the flow and the ground-truth MU information of the packet, wherein the one or more MU detection criteria are usable to detect MU information of the packet of the flow.

### CROSS-REFERENCE TO RELATED APPLICATIONS

This application is a continuation of International Application No. PCT/EP2023/072198, filed on Aug. 10, 2023, the disclosure of which is hereby incorporated by reference in its entirety.

### FIELD

The present disclosure relates to communication networks, and particularly to information detection for packet flows in communication networks.

### BACKGROUND

The packets belonging to an application, which are transmitted by the network, have different importance to the application. As of today, in case of network congestion, packets are dropped randomly, without consideration of whether a packet might have high or low importance to the application. One of the limitations thereby is that so far, there is no efficient and reliable way to determine the importance of a packet. Hence, no intelligent application-aware prioritization or dropping of packets can be conducted in 3GPP networks.

With the introduction of the P-Trace or Real-Time Transport Protocol (RTP) header extension in TS 26.522, relevant information about the packets' importance level can be provided to the network. However, the solution is only applicable to a limited extent. Fully relying on the P-trace or RTP header extension has the drawback that in many cases, it might not be provided. For instance, the application provider is not willing to share such information or because the application server does not support the generation of RTP header extension or P-trace. But even if the P-trace or RTP header extension is available, it might not be accessible by the mobile network, due to traffic encryption (please note that most traffic nowadays is encrypted). Finally, even if there is no encryption, checking the P-trace/extended RTP header for each packet is in-efficient and may slow down the operations.

Due to the limited functionality of deriving a packet's importance, mechanisms today still rely on random packet drops. This has negative effects on the quality of the application and also on the Quality of Experience (QoE) as perceived by the user.

### SUMMARY

A more intelligent dropping of packets can only be realized if it is known which type of content they contain. In accordance with an embodiment, the present disclosure derives relevant information about the packets' importance without accessing the packet headers. In accordance with another embodiment, the present disclosure applies the aforementioned approach to arbitrary traffic flows, i.e., generically for any application- and network-specific setting.

A first aspect of the disclosure provides a network entity for media unit (MU) information detection of a packet in a flow, wherein the flow comprises a plurality of packet sets, and each packet set carries a MU that requires the same treatment in the network. The network entity is configured to: obtain at least one of application-level information of the flow, and ground-truth MU information of the packet, wherein the application-level information comprises information regarding an application-specific setting and/or a network-specific setting related to the flow; and generate one or more MU detection criteria for the flow based on the at least one of the application level information and the ground-truth MU information of the packet, wherein the one or more MU detection criteria are usable to detect MU information of the packet of the flow.

A media unit (MU) denotes a set of packets that belongs to one media content, which has similar importance for the application and requires similar Quality of Service (QoS) treatment in the network. It may also be referred to as a packet set, or a Protocol Data Unit (PDU) set, in this disclosure. For example, one MU may comprise all packets belonging to an I-Frame of a video, while another MU comprises all packets belonging to a P-Frame of a video. Accordingly, MUs may be associated with an importance level, such that packets that belong to a high-importance MU can be treated in the network with higher QoS priority, allowing for improved QoE.

In accordance with another embodiment, the present disclosure provides a network entity that can explore the use of two different types of information: 1) application-level information 2) ground-truth MU information, to generate a logic that can generically derive MU information of a packet, in order to be able to derive information about the importance for the packet.

In an implementation form of the first aspect, the application-level information comprises at least one of the following:
an application identifier,
a packet filter set,
a used protocol type of the flow,
an application setting, and
pairing information of uplink (UL) and downlink (DL) traffic.

Notably, there may be a vast amount of settings on the application level and network level, such as used protocol, number of video quality levels, codec-specific configurations, video segment duration, live vs. on-demand streaming, etc. These settings could form a huge space of possible settings and different settings may result in a different relationship between the network traffic and the transmitted MU. The network entity can make use of the relevant application- and protocol-specific information to determine the MU detection criteria faster and in such a way that it may also provide higher accuracy.

In an implementation form of the first aspect, the ground-truth MU information of the packet comprises at least one of the following:
P-trace information, and
a header extension.

Optionally, the information contained in the P-Trace and/or in the RTP packet header can provide the MU information of a packet. The ground-truth MU information may include full information about the MUs, e.g., packet number in a unit, media type importance, and the size of the MU.

In an implementation form of the first aspect, the application-level information is obtained

from an application function (AF).

In an implementation form of the first aspect, the ground-truth MU information of the packet is obtained from a user plane function (UPF) or an AF.

Possibly, the AF may provide no information, limited information, or all relevant information regarding the application.

In an implementation form of the first aspect, at least a part of the application-level information is further determined by the network entity by using a machine learning (ML) model.

For instance, application settings and the used protocol type of flow may be derived by the network entity.

In an implementation form of the first aspect, the network entity is further configured to obtain traffic statistics related to the flow, wherein the traffic statistics comprise UL- and DL-related packet statistics from the flow, or packet statistics of the flow and packet statistics of a corresponding uplink or downlink flow of that flow; and determine the application-level information using the ML model using the traffic statistics as an input.

Notably, there might be both uplink and downlink packets in one service data flow from the application. Such traffic statistics may be used by the network entity for determining the application-level information. Further, for a UL/DL flow, there will be corresponding DL/UL flow(s). Such a pair of an uplink flow and a corresponding downlink flow may also be named paired flows. Packet statistics of paired flows may also be used by the network entity for determining the application-level information. Such traffic statistics may include different statistics on the packet sizes, covering a dynamic range of the past (i.e. the last x seconds or last y packets). Optionally, the traffic statistics may include maximum, minimum, average, standard deviation, percentiles, etc. of a number of packets/sent packets of a given period. The traffic statistics may also include protocol-dependent UL/DL paring information for predicting MUs. It may be understood that certain UL packet statistics trigger upcoming MUs on downlink. For example: UL packet can be a request of a video segment. This indicates that soon there will be DL traffic and the first couple of packets would then belong to an I-Frame (MU of high importance).

In an implementation form of the first aspect, the traffic statistics related to the flow are obtained from a UPF.

In an implementation form of the first aspect, the network entity is further configured to obtain a MU detection template related to an application; and derive the one or more MU detection criteria based on the MU detection template and the application-level information.

This disclosure further exploits the fact that flows using the same application- and protocol-setting have common behavior and thus a similar relationship between network-related features and MU transmission. Therefore, the use of templates may simplify the derivation of MU detection criteria. Templates for an arbitrary application/protocol combination are obtained by the network entity, and by using the information concerning the flow's network characteristics, specific values for filling the templates are determined. The combination of the derived values and the template results in the final MU detection criteria.

In an implementation form of the first aspect, the MU detection template is obtained from an external network entity or generated by the network entity.

Optionally, the external network entity can be a management plane network entity, another network entity of the same type (e.g., a network data analytics function for model training (NWDAF-MTLF) when the consumer is NWDAF for analytics generation (NWDAF-AnLF)), or a different type (e.g. an NWDAF when the consumer NF is a session management function (SMF)).

In an implementation form of the first aspect, the MU detection template is represented by a decision tree, and the network entity is configured to derive one or more parameters for the decision tree using the application-level information, and fill the decision tree with the one or more parameters to derive the one or more MU detection criteria.

The decision tree is a simple form of the MU detection template. It represents generic relationships between network features and MU information.

In an implementation form of the first aspect, the one or more MU detection criteria are parameterized for the application-specific setting and/or the network-specific setting.

Optionally, one MU detection criteria may be used for several flows, where the parameters can be relative values. Notably, this may reduce the signaling overhead between the network entity and the devices utilizing the MU detection criteria (e.g. the UPF).

In an implementation form of the first aspect, the network entity is further configured to provide the one or more MU detection criteria directly or indirectly to a first network entity, for the first network entity to use for detecting MU information of a packet.

Possibly, the first network entity may be the UPF.

In an implementation form of the first aspect, the MU information of a packet comprises one or more of the following: an indication of a start and/or end of the MU, a type of the MU, a size of the MU, and an importance of the MU.

The MU information can be provided by the Extended Reality (XR) server.

In an implementation form of the first aspect, the network entity is a controller and/or is implemented in a NWDAF.

Optionally, the NWDAF may collect application-level information, and/or packet statistic information, and further derive the MU detection criteria.

In an implementation form of the first aspect, the network entity is further configured to obtain the application-level information of the flow from an application function via a network exposure function (NEF) or a user data repository (UDR) function, or from an SMF; and notify the one or more MU detection criteria to a second network entity.

Possibly, the second network entity may be a consumer network entity. For instance, it may be another NWDAF or the SMF, which may further adjust the MU detection criteria by further training or adding the value of some parameters in the MU detection criteria. That is, the MU detection criteria may not be directly used for MU detection. It may be understood that possibly the MU detection criteria may not be directly sent to the second network entity, but be indicated to the second network entity.

In an implementation form of the first aspect, the network entity is a controller and/or is implemented in a SMF.

Optionally, the SMF may collect application-level information, and/or packet statistic information, and further derive the MU detection criteria.

In an implementation form of the first aspect, the network entity is further configured to obtain the application-level information of the flow from an application function via a policy control function (PCF); and notify the one or more MU detection criteria to the first network entity.

In an implementation form of the first aspect, the network entity is further configured to obtain an indication from a PCF, wherein the indication indicates the network entity to derive the one or more MU detection criteria; configure a UPF to provide the traffic statistics related to the flow to the network entity; and configure the UPF on MU detection based on the one or more MU detection criteria.

Possibly, the PCF may determine MU level QoS treatment of a certain service flow and indicate the SMF to enable MU detection with protocol information using policy association procedure.

A second aspect of the disclosure provides a method for MU information detection of a packet in a flow, wherein the flow comprises a plurality of packet sets, and each packet set comprises a MU that requires the same treatment in the network. The method comprises: obtaining at least one of application-level information of the flow, and ground-truth MU information of the packet, wherein the application-level information comprises information regarding an application-specific setting and/or a network-specific setting related to the flow; and generating one or more MU detection criteria for the flow based on the at least one of the application-level information and the ground-truth MU information of the packet, wherein the one or more MU detection criteria are used for detecting MU information of packet of the flow.

Implementation forms of the method of the second aspect may correspond to the implementation forms of the network entity of the first aspect described above. The method of the second aspect and its implementation forms achieve the same advantages and effects as described above for the network entity of the first aspect and its implementation forms.

A third aspect of the disclosure provides a computer program product comprising a program code for carrying out, when implemented on a processor, the method according to the second aspect and any implementation forms of the second aspect.

A fourth aspect of the disclosure provides a computer-readable medium comprising instructions which, when executed by a computer, cause the computer to carry out, the method according to the second aspect and any implementation forms of the second aspect.

It has to be noted that all devices, elements, units, and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements or any kind of combination thereof.

### BRIEF DESCRIPTION OF DRAWINGS

The above-described aspects and implementation forms of the present disclosure will be explained in the following description of specific embodiments in relation to the enclosed drawings, in which:

FIG. 1 shows examples of the different importance of frames/layers;

FIG. 2 shows an example of encrypted packets belonging to different MUs;

FIG. 3 shows a network entity according to an embodiment of this disclosure;

FIG. 4 shows an example deployment of the network entity in 3GPP network architecture according to an embodiment of this disclosure;

FIG. 5 shows a two-step approach for deriving the MUD criteria according to an embodiment of this disclosure;

FIG. 6 shows exemplary (simplified) MUD criteria according to an embodiment of this disclosure;

FIG. 7 shows an exemplary (simplified) MU detection template according to an embodiment of this disclosure;

FIG. 8 shows a workflow within the MUD controller according to an embodiment of this disclosure;

FIG. 9 shows a sequence diagram when the MUD controller is implemented in NWDAF according to an embodiment of this disclosure;

FIG. 10 shows a sequence diagram when the MUD controller is implemented in NWDAF according to an embodiment of this disclosure;

FIG. 11 shows a sequence diagram when the MUD controller is implemented in SMF according to an embodiment of this disclosure; and

FIG. 12 shows a method according to an embodiment of this disclosure.

### DETAILED DESCRIPTION OF EMBODIMENTS

In order to improve transmission efficiency in a communication network, and to provide a better service experience for users, the present disclosure provides treating different packets differently in a network. To this end, the disclosure provides a network entity and a corresponding method, for media unit (MU) information detection of a packet in a flow.

Illustrative embodiments of the network entity and corresponding method for MU information detection of a packet in a flow are described in the following with reference to the figures. Although this description provides a detailed example of possible implementations, it should be noted that the details are intended to be exemplary and in no way limit the scope of the application.

Moreover, an embodiment or example may refer to other embodiments or examples. For example, any description including but not limited to terminology, element, process, explanation, and/or technical advantage mentioned in one embodiment or example is applicative to the other embodiments or examples.

As previously discussed, the packets belonging to an application, which are transmitted by the network, have different importance to the application. For example, typical video-streaming and -encoding solutions rely on an I-, P-, B-frame structure, where the I-frame contains the whole image information, while P-, and B-frames only encode the difference as compared to the I-frame. This makes video streaming efficient, as P- and B-frames are comparably cheap in terms of encoding. However, if an I-frame gets disturbed (e.g. because some of its packets are dropped), the visual quality degradation is passed on for a couple of frames, as P- and B-frames rely on the I-frame as a reference. For instance, if an I-frame is distorted, the complete video segment may be distorted. Hence, when it comes to video streaming, packets carrying (parts of) an I-frame should be treated with high priority, while degradations of P- and B-frames can be better accepted.

It is similar to Scalable Video Streaming (SVC). A base layer is definitely transmitted to the user, allowing the user to play back the video with moderate quality. Depending on the bandwidth between the client and the server, one or more enhancement layers can additionally be transmitted. With each additional enhancement layer, the visual quality of the played-back video improves. While the base layer may be required for smooth playback of the video, enhancement layers only put an additional level of quality to the video. The base layer consequently has the highest priority, while the importance of an enhancement layer decreases with the number of already transmitted enhancement layers.

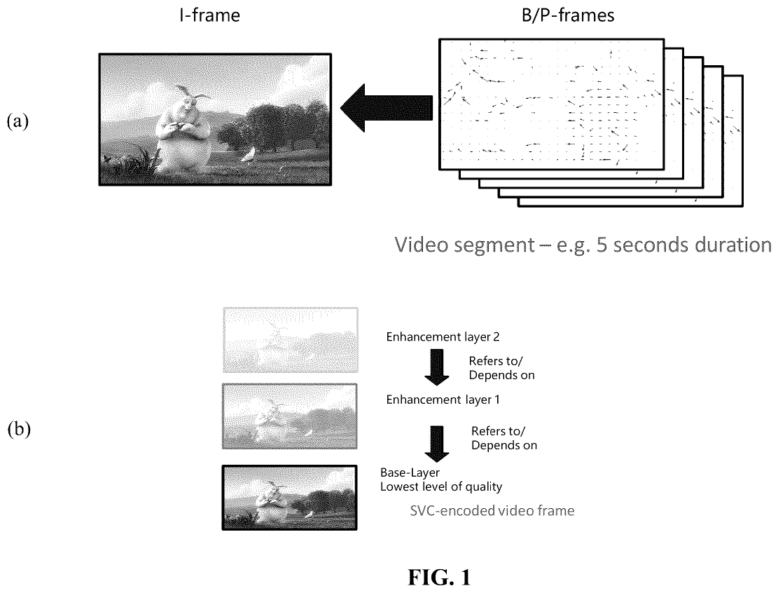

Even within one flow associated with one application, different packets have varying importance to the application and hence should be treated with different priorities. FIG. 1 illustrates two examples of varying importance when it comes to video streaming. FIG. 1(a) shows an I-frame, which contains the complete image information and thus should be delivered with high priority, and B/P-frames, which only encode the differences compared to the I-frame they refer to. If the I-frame is distorted, the whole video segment is distorted. Therefore, dropping packets belonging to an I-frame should be avoided. FIG. 1(b) shows an example of layer coding where enhancement layer 2 depends on enhancement layer 1 and enhancement layer 1 depends on the base layer. Packet importance decreases with increasing enhancement layer.

As previously discussed, a MU denotes a set of packets that belongs to one media content. For example, one MU may be all packets belonging to an I-Frame, while another MU comprises all packets belonging to a P-Frame. Accordingly, MUs may be associated with an importance level, such that packets that belong to a high-importance MU can be treated in the network with higher QoS priority, allowing for improved QoE. The MU information can be provided by the XR server.

MU information may comprise one or more of the following: starting/ending of a MU, type of the MU, size of the MU, and importance of the MU.

There are different possibilities for how the application may communicate the MU information to the network. One example is the usage of a P-Trace, as shown in Table 1. For one packet, the P-trace denotes relevant information such as the importance (e.g. high for an I-frame, low for a B-frame) or the number of the current packet of the MU.

TABLE 1

| Name | Type | Semantics |
|---|---|---|
| number | BIG | Unique packet number in the delivery |
| | INT | |

Baseline parameters

| | | |
|---|---|---|
| availability_time | BIG | Availability time of packet for next processing step |
| | INT | relative to start time 0 in microseconds (0 means lost). |
| size | BIG | Packet size in bytes. |
| | INT | |
| flow_id | BIG | An id to the flow in order to differentiate different QoS |
| | INT | flows |

Cross-Layer Parameter

| | | |
|---|---|---|
| buffer | BIG | The associated eye buffer 1 = left 2 = right |
| | INT | In general, differentiates application traffic for different |
| | | buffers, for example, audio, video, left eye, and right eye. |
| delay | BIG | The delay observed of the packet in the last processing |
| | INT | step (−1 means lost) |
| render_timing | BIG | The rendering generation timing associated with the |
| | INT | media included in the packet. |
| number_in_unit | BIG | The number of packets within the unit (slice), starts at 1 |
| | INT | |
| last_in_unit | BIG | Indicates if this is the last packet in the slice/unit 0 = no, |
| | INT | 1 = yes |
| type | BIG | The data type of unit, e.g., 0 unknown |
| | INT | For video 1 = intra 2 = inter |
| importance | BIG | Assigned relative importance information (higher number means higher |
| | INT | importance) |

Another example of how MU-related information can be provided is the RTP header. The one-byte RTP Header Extension Format (in TS 26.522) is defined as follows:

Thereby, relevant information concerning the packet and its corresponding MU is injected into the packet. The “E” bit indicates the End PDU of the PDU Set, “EDB” indicates the end of Data Burst, “PSI” represents PDU Set Importance that indicates the importance of this PDU Set compared to other PDU Sets within the same RTP stream, “PSSN” represents PDU Set Sequence Number that encodes the sequence number of the PDU Set to which the current PDU belongs, “PSN” represents PDU Sequence Number within a PDU Set that indicates the sequence number of the current PDU within the PDU Set, “PSSize” represents PDU Set Size that indicates the size of a PDU set.

With the introduction of the P-Trace or RTP header extension (TS 26.522), relevant information about the packets' importance level can be provided to the network.

An existing work provides discarding packets of less importance to reduce video quality degradation. It provides a method to recognize the video packet types (i.e. whether they carry content for an I-Frame, P-Frame, or B-frame) from header information and evaluates its accuracy and the effect of the intelligent drop on the video quality delivered to the user. Such a mechanism, which relies on packet-header information and traffic patterns such as the inter-arrival time, is applied for a WiFi setting. Although the packet payload data is not inspected, the inspection of the packet header data can already be very time-consuming and thus limiting the practical usability of the approach. Apart from this, the approach can only be applied to the specific WiFi setting and is not generalizable to other environments, such as a mobile network.

Another work provides a classification approach to distinguish different frame types by employing simple statistical features in the MAC layer scheduler (and potentially other network locations). Incoming traffic is classified and future frames are predicted. The same issue of limited generalizability and usability of the approach is faced in this work. It is limited to the very specific setting under study: videos encoded using H.265, on-demand streaming, and respectively one specific application- and network protocol.

However, there is a vast amount of settings on the application level and network level: Used protocol, number of video quality levels, codec-specific configurations, video segment duration, live vs. on-demand streaming, etc. These settings form a huge space of possible settings and different settings result in a different relationship between the network traffic and the video frame types.

Due to the limited functionality of deriving a packet's importance, mechanisms today still rely on random packet drops. This has negative effects on the quality of the application as perceived by the user—the Quality of Experience (QoE). While intelligent dropping mechanisms would bring the benefit of providing a much better user experience, at the same network load. For example, if the packet of an I-frame is dropped and hence the quality of the frame is degraded, all subsequent depending P-frames cannot be decoded properly, which can lead to a quality degradation that persists for the duration of a whole video segment (e.g. 5 seconds). Contrary, dropping a packet belonging to a P-frame may only affect the current frame and reduce the duration of quality degradation to fractions of a second.

A more intelligent dropping of packets can only be realized if it is known which type of content they contain (e.g. very important I-frame vs. less important P-frame). Due to the overhead of inspecting each packet's content and due to encryption, the MU information should be derived without inspecting the packet.

To date, there is no efficient way that allows to generically derive media unit information (e.g. different video frame types) for an arbitrary application configuration and different network characteristics. To achieve this, this disclosure introduces a first mechanism, which determines (or obtains) all information regarding the application- and network-specific settings (used protocols, configurations such as the encoding technique, etc). Once this information is present, this disclosure further provides a second mechanism that can actually determine the MU information from the traffic patterns.

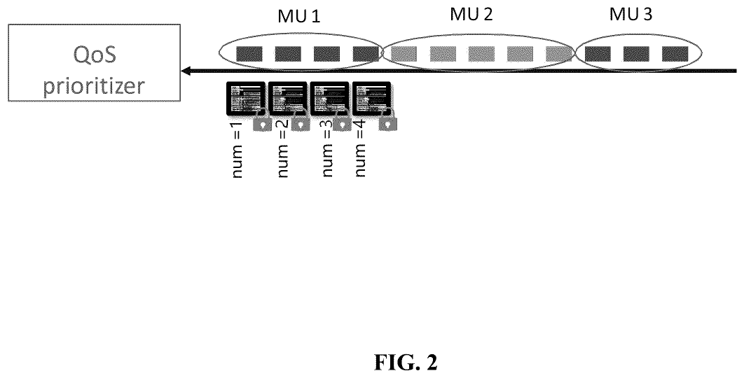

Different packets should be treated differently in the user plane (UP) entities/network (e.g. being prioritized for packet transmission/priority-aware dropping), depending on their importance for the application. For that, information needs to be available, indicating the importance of a packet. Using the P-trace, each packet can be marked with the corresponding information. Then, a QoS prioritizer can treat the packets accordingly. However, detecting the importance of a packet using the P-trace has several drawbacks: i) it requires the willingness of the XR application to share such information (not always the P-trace will be available for all packets); ii) the mechanism is inefficient, as it requires to inspect each packet; and iii) as soon as packets are encrypted, the P-trace (information) is not accessible anymore (as outlined in FIG. 2).

To solve this problem, one can derive the MU information without accessing the contents of the packet by analyzing the traffic patterns: (Media streaming) applications behave in specific patterns, which has an impact on the resulting data transmission. Accordingly, from observed network traffic patterns, one can conclude about various application specifics, such as the current media unit that is transported. Hence, to be capable of deriving such MU information, the relationship between the network (statistics) and the application needs to be known.

The problem is, however, that this relationship is strongly depending on many specific configurations on the application- and network-level. For video streaming, for example, the settings, which influence the relationship between network statistics and MU, include but are not limited to the following parameters:

### Application-Specific:

Type of streaming application: Video-on-Demand (VoD) streaming vs. live streaming, 360-degree streaming vs. omnidirectional streaming, SVC-based streaming.
Video player settings: Thresholds for pausing and resuming the playback, maximum buffer thresholds, applied quality adaption heuristic.
Video and encoding characteristics: Video segment duration, available quality levels, and their bitrate characteristics used codec (e.g. VP9 vs. H.264, H.265).
Protocol used on the application level (e.g. HTTP adaptive streaming (HAS), WebRTC, RTP).

Network-specific settings relate to the underlying network-layer protocol that is used for transporting video streaming. For example, streaming content may be delivered via TCP or UDP.

The goal of the present disclosure is to enable the retrieval of relevant MU information without the need of accessing application packet header information or other MU information directly contained in the packet during inference. More specifically, the disclosure addresses the following two technical problems: how to derive the MU information through analyzing packet meta-data and traffic patterns and statistics, and how to make the provided approach applicable to arbitrary traffic flows, i.e., generically for any application- and network-specific setting.

To solve this problem, this disclosure, in an embodiment, provides a network entity, namely, MU Detection Controller (MUD Controller), and its included method for deriving a MU detection criteria (MUD Criteria) for a given (multi-media streaming) application flow. The MUD Criteria is a logic, which allows to derive information about the Media Unit (e.g., the size of the media unit and/or the type) that a packet (or a group of packets) carries based on packet (meta-) statistics only. For instance, the content of the packets does not need to be accessed.

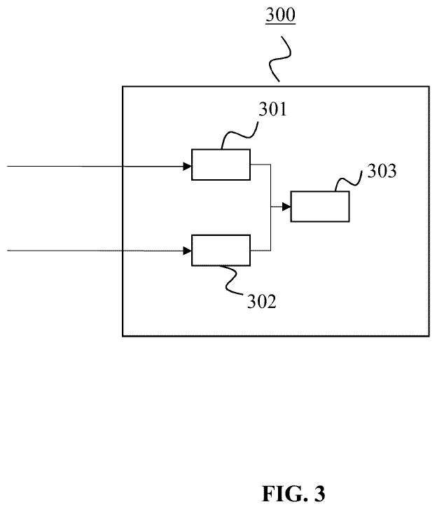

FIG. 3 shows a network entity 300 adapted for MU information detection of a packet in a flow. In particular, the flow comprises a plurality of packet sets, and each packet set carries a MU that requires the same treatment in the network.

In this disclosure, a packet set, or a MU, or a PDU set, denotes a set of packets that belongs to one media content, which has similar importance for the application and requires similar Quality of Service (QoS) treatment in the network. For example, one MU may comprise all packets belonging to an I-Frame of a video, while another MU comprises all packets belonging to a P-Frame of a video. Accordingly, MUs may be associated with an importance level, such that packets that belong to a high-importance MU can be treated in the network with higher QoS priority, allowing for improved QoE.

The network entity 300 may comprise processing circuitry (not shown) configured to perform, conduct or initiate the various operations of the network entity 300 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The network entity 300 may further comprise memory circuitry, which stores one or more instruction(s) that can be executed by the processor or by the processing circuitry, in particular under the control of the software. For instance, the memory circuitry may comprise a non-transitory storage medium storing executable software code which, when executed by the processor or the processing circuitry, causes the various operations of the network entity 300 to be performed. In one embodiment, the processing circuitry comprises one or more processors and a non-transitory memory connected to the one or more processors. The non-transitory memory may carry executable program code which, when executed by the one or more processors, causes the network entity 300 to perform, conduct or initiate the operations or methods described herein.

The network entity 300 is configured to obtain at least one of application-level information 301 of the flow, and ground-truth MU information 302 of the packet. In particular, the application-level information 301 comprises information regarding an application-specific setting and/or a network-specific setting related to the flow. The network entity 300 is further configured to generate one or more MU detection criteria 303 for the flow based on the at least one of the application-level information and the ground-truth MU information 302 of the packet. The one or more MU detection criteria 303 are usable to detect MU information of the packet of the flow.

Notably, this disclosure provides exploring the use of two different types of information: 1) application-level information 2) ground-truth MU information, to generate a logic that can generically derive MU information of a packet, in order to be able to derive information about the importance for the packet.

This disclosure provides a network entity 300, which is capable of generically (i.e. for a multitude of multi-media services) determining a logic (i.e., MU detection criteria 303) that can retrieve MU information from a combination of the application-level information 301 and the ground-truth MU information 302. The network entity 300 may be an Artificial intelligence (AI)/ML-capable network entity, which can derive the MU detection criteria to be applied to the packets of an application traffic flow in a mobile network.

According to an embodiment of the disclosure, the network entity 300 may receive during a training phase packet statistics of both UL and DL directions of an application traffic flow, relevant application- and protocol-specific information (e.g., the type of protocol used), and information regarding the MU (via the P-trace or the RTP header; serves as the ground-truth).

Optionally, the application-level information 301 may comprise at least one of the following:
an application identifier,
a packet filter set,
a used protocol type of the flow,
an application setting, and
pairing information of uplink and downlink traffic.

Optionally, the ground-truth MU information 302 of the packet may comprise at least one of P-trace information and a header extension (e.g., the RTP header).

P-Trace and RTP header provide the MU information. This information may be used during the training phase as a ground-truth during the training of the ML model, which later derives the one or more MU criteria 303. More specifically, the packet statistics (on both UL and DL) are correlated with the MU information, for example, obtained from P-trace or RTP packet header, to learn the relationship between traffic patterns and MUs. Once the relationship is sufficiently learned, the MU information can later be derived solely from the packet statistics.

Possibly, the application-level information 301 may be obtained from an AF, while the ground-truth MU information 302 of the packet may be obtained from a UPF or an AF.

According to an embodiment of the disclosure, the network entity 300 may be configured to obtain traffic statistics related to the flow, in particular, from a UPF. The traffic statistics comprise UL- and DL-related packet statistics from the flow, or packet statistics of the flow and packet statistics of a corresponding uplink or downlink flow of that flow. The network entity 300 may be further configured to determine the application-level information 301 using the ML model using the traffic statistics as an input.

During an inference phase, the information regarding the MU may not be needed anymore. Instead, based on the traffic statistics, the network entity may derive a parameterized MU detection criteria (i.e., MU detection criteria 303) for the application/protocol setting and provides it to another network entity in the mobile network.

This MU detection criteria 303, used by the other network entity, use UL/DL traffic correlations (i.e., pairing information of UL/DL traffic) as well as further values and variables from the current flow.

In particular, some MU detection criteria 303 may include parameters without a fixed value/threshold, but parameters that are represented as relative values or variables.

Notably, the present disclosure allows controlling the detection of MUs and MU types solely based on traffic statistics. In accordance with another embodiment, the present disclosure provides combining UL and DL traffic statistics, thus exploiting knowledge of the UL/DL correlation of packets. That is, the network entity 300 can be made aware of (e.g. by means of ML training) the relationship of UL/DL traffic for different applications and protocols. This UL/DL correlation is used by the network entity 300 when determining the one or more MU detection criteria 303. The combined observations on uplink and downlink allow the MU detection criteria 303 to derive reliable conclusions about the MUs.

The approach is adaptive to the scope of information provided by the application (e.g., via the AF): The AF may provide no information, limited information, or all relevant information regarding the application. The network entity 300 can make use of the information provided via the AF to determine the one or more MU detection criteria 303 faster and with a higher accuracy. However, if information (such as the specific type of application or the used protocol) is not available or only partially available, the network entity 300 can (by means of additional ML models) determine such information from the observed packet/traffic statistics. That is, at least a part of the application-level information 301 can be determined by the network entity 300 by using an ML model.

This may be realized by means of a two-step approach, where one step is determining the application type and used protocol, and the second step is, depending on the first step and/or information provided via the AF, to determine the one or more MU detection criteria 303.

According to an embodiment of the disclosure, the network entity 300 may be configured to obtain a MU detection template related to an application; and derive the one or more MU detection criteria 303 based on the MU detection template and the application-level information 301.

It may be worth mentioning that the relationship between traffic patterns and MU information is generally similar between different flows that are using the same application and protocol. This characteristic can be exploited when deriving the one or more MU detection criteria 303: so-called MUD templates describe (e.g., in the form of a decision tree) the basic relationship between traffic statistics and MU information.

These templates may be generated by means of using ML models, by means of manpower, or a combination of both. Optionally, the MU detection template may be obtained from an external network entity or generated by the network entity 300. After the application/protocol for a flow is determined, the network entity 300 only needs to derive specific values (e.g. specific for the available bandwidth or the observed delay of that flow) which are combined with the given template.

It should be noted that the output of the MU detection criteria 303 is a compute logic (e.g., an ML-based model such as a decision tree or a neural network), and not a dedicated result. The MU detection criteria 303 encodes the application-/protocol-specific relationships between network traffic patterns/statistics and the MU information and thereby considers the characteristics (e.g., delay) of a given flow. The MU detection criteria 303 utilizes a combination of relative and fixed numbers. In particular, the one or more MU detection criteria 303 derived by the network entity 300 is parameterized, whereby parameters may be expressed relative to other sizes (to network-related parameters such as the throughput or application-related ones such as the video segment size). This allows to re-use of the same MU detection criteria 303 for a multitude of flows and reduces the signalling that may be required between a particular network entity running the MU detection criteria 303 (e.g. the UPF) and the network entity 300 deriving the MU criteria 300 (e.g., a controller in the SMF).

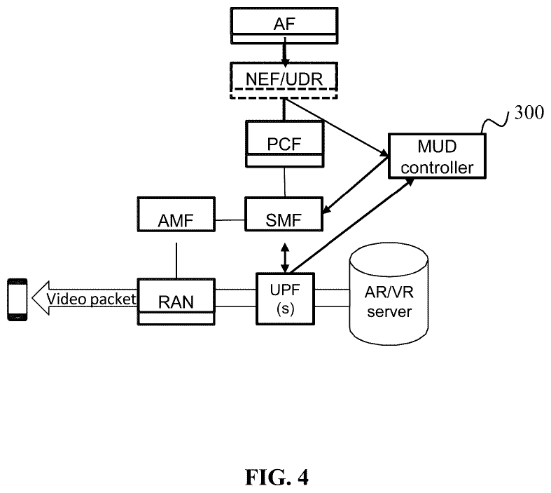

In this disclosure, the network entity 300 may also be named as MU detector, or MUD controller as it may be implemented as a controller. FIG. 4 shows an example of the MU detector in a 3GPP network. The MU detector, which may be deployed in the SMF, derives the MU detection criteria 303, which is later deployed in the UPF. For the DL traffic, the UPF applies the MU detection criteria 303 to derive the MU information of each packet. For instance, the detected MU information is marked in the header (e.g., GPRS tunneling protocol (GTP) header) of the packets accordingly and sent to a radio access network (RAN). Then, the RAN can treat the packets with different priorities according to the importance of the MU to which the packet belongs.

In the following part, features provided by this disclosure are discussed in detail.

### Input for the MUD Controller

The MUD controller collects various information as input from the AF and/or the UPF. Such information is relevant for the training or later on for inference. The inference happens where the MUD Criteria is running (e.g., by the UPF). The data is thus needed in the MUD controller during the training. Input information provided to the MUD controller is provided in Table 1. Notably, the column “Relevance for Training” in Table 1 is more relevant to the MUD controller, while “Relevance for Inference” is provided here for the sake of completeness.

TABLE 1

| | | | Relevance for | Relevance for |
|---|---|---|---|---|
| Input Data | Source | Description | Training | Inference |
| Application ID | UPF or | Application identifier as | Required (for | Optional (can be |
| | AF | defined in TS 23.501 clause | uniquely | used instead of |
| | | 5.8.2 (an index to a set of | identifying the | the used protocol |
| | | application detection rules | type of | and/or |
| | | configured in the UPF). In | application) | application |
| | | another option: the | | configuration) |
| | | Application ID could | | |
| | | already encode app-level | | |
| | | info (such as the expected | | |
| | | level of user interactivity, | | |
| | | video segment duration, | | |
| | | etc.) | | |
| IP packet filter | UPF or | IP Packet Filter set as defined | Mandatory | Mandatory |
| set | AF | in TS 23.501 clause | (indicates the | (indicates the |
| | | 5.8.2 (source/destination IP | UL/DL flow used | UL/DL flow |
| | | IP Packet Filter set as | for training) | used for the |
| | | defined in TS 23.501 clause | | inference) |
| | | and port numbers, above | | |
| | | protocol ID, ToS, flow label | | |
| | | (IPv6), . . . ) | | |
| Application | AF | Any further information | Optional (but | Optional (but |
| configurations | | describing basic application | recommended, the | recommended, |
| | | configurations, such as the | more information | the more |
| | | fps, number layers, segment | the better the | information the |
| | | duration, coding, I-frame | accuracy) | better the |
| | | interval, expected user | | accuracy) |
| | | interaction | | |
| Used protocol | AF | | Mandatory | Optional |
| type | | | (ground-truth may | |
| | | | be required for | |
| | | | training a model, | |
| | | | which can retrieve | |
| | | | the application | |
| | | | and protocol a | |
| | | | flow is using) | |
| P-Trace/RTP | UPF | Full information about the | Mandatory | Optional |
| extension | | media units (MUs) → packet | (ground-truth may | |
| header | | number in the unit, media | be required for | |
| | | type importance, size of the | training a model, | |
| | | MU | which can retrieve | |
| | | | the MU type a | |
| | | | packet belongs to) | |
| Packet statistics | UPF | Different statistics on the | Mandatory | Mandatory |
| on UL and DL | | packet sizes, covering a | | |
| | | dynamic range of the past | | |
| | | (i.e. the last x seconds or last | | |
| | | y packets). These statistics | | |
| | | can be: maximum, | | |
| | | minimum, average, standard | | |
| | | deviation, percentiles, etc. of | | |
| | | a number of packets/sent | | |
| | | packets of a given period. | | |
| Packet inter- | UPF | Various statistics on the past | Mandatory | Mandatory |
| arrival times | | IATs (e.g. last x seconds or | | |
| (UL and DL) | | last y packets). Similar as the | | |
| | | statistics relating to the | | |
| | | packet size. | | |
| Paired UL/DL | UPF | Proctocol-dependent UL/DL | Mandatory | Mandatory |
| statistics (e.g. | | correlations for predicting | | |
| time between | | MUs. Certain UL packet | | |
| UL packet and | | statistics trigger upcoming | | |
| first respective | | MUs on DL. For example: a | | |
| DL packet) | | UL packet can be the request | | |
| | | of a video segment. This | | |
| | | indicates that soon there will | | |
| | | be DL traffic and the first | | |
| | | couple of packets would | | |
| | | then belong to an I-Frame | | |
| | | (MU of high importance) | | |

### Two-Step Approach for Deriving MUD Criteria

According to an embodiment of this disclosure, the MU detector applies a two-step approach and AI/ML algorithms to:
1. Detect the application and protocol that is used for the current flow (optional, this step is performed if the information is not provided by the AF).
2. Derive the MU detection criteria for that flow.

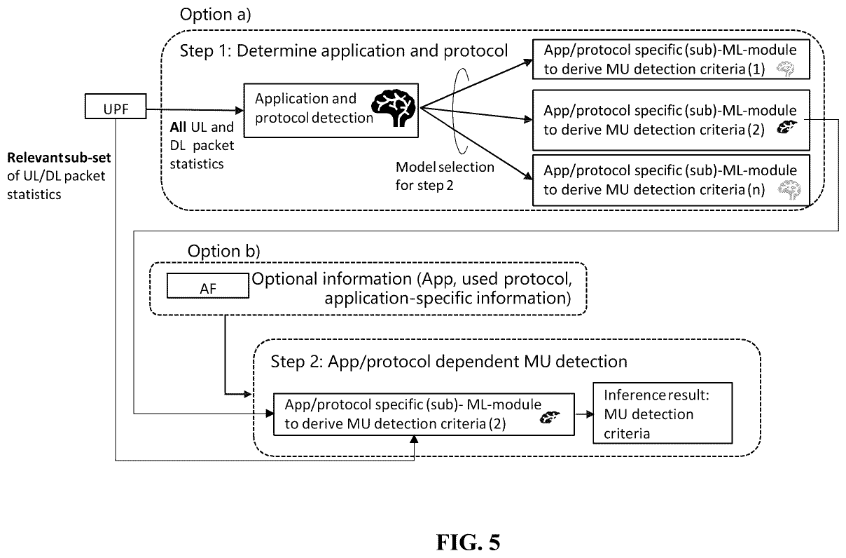

FIG. 5 illustrates an example of the two-step approach for deriving the MU detection criteria. It is assumed that all ML models that have been trained, can provide sufficient accuracy, and are available at the MUD controller (i.e., the network entity 300 as shown in FIG. 3).

In Step 1, the application and protocol of the flow are determined by means of an ML model. The ML model uses different UL- and DL-related packet statistics provided by the UPF (Option a) as shown in FIG. 5). These statistics are used to determine which application (e.g. adaptive video streaming) and which protocols are used (e.g. HTTP adaptive streaming (HAS) via Transmission Control Protocol (TCP)). However, the application (provider) may provide such information. In this case (represented in FIG. 5 as Option b)) the ML model from Option a) is not necessary and the step can be skipped. Information about the used application and used protocols are communicated via the AF.

In the MUD controller, a set of different further sub-ML-models are available. These sub-ML-models are specific to a combination of the used application and protocol. For example, there may be one model for adaptive video streaming via the HTTP protocol and another model for adaptive video streaming via the RTP protocol. Once the used application and protocol are determined (either via Option a) by ML-based detection or via Option b) where the information is provided by the application (e.g. via the AF)), Step 2 can be applied. In Step 2, the application/protocol-specific model is used to finally derive the MU detection criteria. It should be noted that in order to execute Step 2, Step 1 needs to be completed (i.e., the application and protocol which are used by the flow are known).

Protocol-/Application-Dependent Exploitation of UL/DL Information to Conclude about the MU

One of the key features of this disclosure is that both of the statistics on UL and DL traffic are used when deriving MU detection criteria. The correlations/interdependencies of UL-DL traffic statistics are exploited to detect MUs. There are different ways to indicate the correlated/paired UL and DL traffic whose features can be combined.

For the UL and DL traffic in the same QoS Flow, it can be indicated with the same flow ID with different flow directions (UL or DL). For the UL and DL traffic in different QoS Flows, there will be two flow IDs each with the direction information. Such correlation information can also be implemented in the form of a table, which is referred to as a correlation/pairing ID. The information on correlated UL and DL traffic is made available to the network entity 300 which derives the MUD criteria (e.g., the SMF), as well as to other network entities running the MUD criteria (e.g. the UPF).

In the following, two representative examples are given on how UL/DL statistics are used to conclude about MUs (I-Frames vs. P-frames in this example).

### 1. HTTP Adaptive Streaming (HAS)

With HAS, the video is split into small segments of a few seconds duration (e.g. 5 seconds). The client requests via an HTTP GET message a video segment. As soon as the requested segment has been fully downloaded, the client sends an HTTP GET request for the next segment. Accordingly, once there is UL traffic (the GET request), DL traffic is soon to come (the requested video segment download). Each video segment starts with an I-frame. Hence, the first couple of packets belongs to the media unit I-Frame, while the remaining packets belong to the media unit P-Frame. The MU detection criteria are capable of determining (or at least estimating) the number of packets belonging to the I-Frame. This is due to the periodicity of video segment arrivals and detectable patterns in the video segment structure (e.g., around 30% of the first packets may belong to an I-frame, remaining packets may belong to P-Frames or B-Frames).

### 2. RTP-Based Video Streaming

With RTP-based streaming, videos are not transmitted on a segment-based granularity (as with HAS), but on single-frame granularity. That means the sender pushes out frame-by-frame toward the server. Again, there is a periodicity in terms of the frame structure, which can be exploited for MU detection. Typically, the I-Frame and P-Frame follow a given pattern (e.g., IPPP IPPP IPPP IPPP). Apart from the periodic structure, the MU detection criteria can exploit frame-type-specific characteristics of the packet inter-arrival times (IATs): I-frames do not need complex encoding and their data can be sent out immediately when available. This leads to a smaller IAT (i.e. packets belonging to I-Frames are transmitted with smaller intervals/gaps between the packets). In contrast, P-Frames may require encoding which takes some time, accordingly, the IAT for P-Frames is typically higher.

There are different reasons for the client to send uplink packets, e.g. acknowledgments or so-called Intra-frame requests (IFR). Intra-frame requests have a specific size and are a clear indicator that subsequent DL packets belong to the requested Intra-Frame (i.e., I-Frame). This means that the MU detection criteria can derive from an UL packet of a specific size, that a certain amount of following DL packets belong to the MU I-Frame.

### MUD Criteria

As previously discussed, the MUD Criteria can be described as a logic that is capable of deriving MU-related information (such as the start/ending of a MU or the MU type of a given packet) from UL and DL statistics collected at the UPF. It can apply ML and it may be a very simple decision tree or a relatively complex approach, such as a neural network.

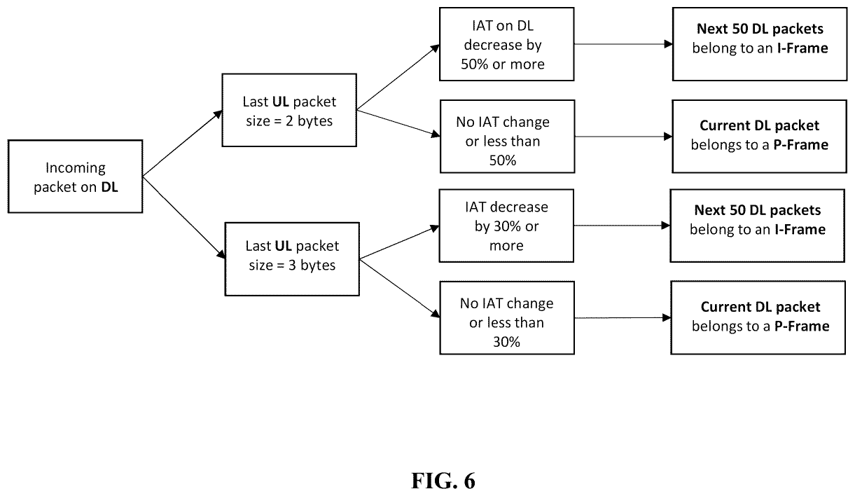

A very simplified and hypothetical example of a MU detection criteria—realized as a decision tree—is denoted in FIG. 6. An incoming DL packet triggers the execution of the MUD criteria and it is first determined whether the last UL packet was having a size of either 2 bytes or 3 bytes. Depending on the outcome of this decision, it is checked if—as compared to a past time interval—the inter-arrival time (IAT) on downlink has decreased by a certain percentage. Based on the IAT information, it may be concluded about a batch of upcoming packets (“next 50 DL packets belong to an I-frame”) or conclusions may be drawn about the current packet (“current DL packet belongs to a P-frame”).

The hypothetical example shall denote what is exploited by the MUD criteria in terms of the key traffic behavior/application characteristic relationship:
Combined features on UL and DL/UL-DL-correlations: Certain uplink packets can give an indication of the DL traffic. For example, an UL packet of a specific size can be a clear indication that an I-Frame has been requested. Accordingly, a given amount of DL packets transmitted after a UL packet of that size belongs to an I-Frame.
Knowledge about the application and its settings: The MU detection criteria exploits the fact that when transmitting I-frames for certain streaming applications (e.g. live streaming), the IAT is shorter because I-frames can be sent out faster as they do not require complex encoding at the server. Furthermore, does MUD criteria encode the (i) sizes of specific uplink packets, as well as (ii) the typical sizes of frames (e.g. 50 DL packets contain one I-Frame)
   Usage of Templates for Determining the MUD Criteria within the MUD Controller

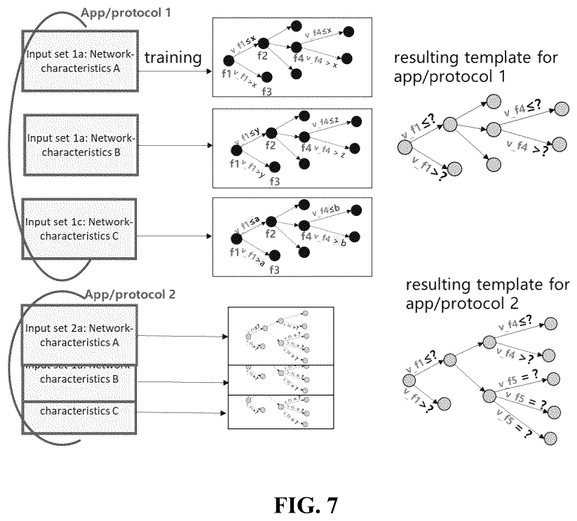

The following part describes one possible way how the MUD criteria can be derived within the MUD controller. FIG. 7 illustrates exemplary MU detection templates, which exploit the fact that flows using the same application- and protocol setting have common behavior and thus a similar relationship between network-related features and MU transmission.

The upper part denotes how the MU detection template can be derived for an arbitrary application/protocol combination (referred to as App/protocol 1). Training is performed for a sufficiently high number of flows. These flows differ with respect to the network characteristics they have (referred to as network characteristics A, B, and C). By means of ground-truth samples (which combine the packet statistics—both on UL and DL—optionally with the P-trace), models are trained which allow to derive the MU information from the network packets. The important point to note is that the generic relationship between the packet statistic and the MU information is very similar for the same application/protocol combination. The only thing that is differing for different flows (that are using the same application/protocol combination) are specific values. That is, in the example of FIG. 7, the structure of the decision tree is the same for any of the three flows (with network characteristics A, B, C), only the specific values (x, y, z, a, b) are differing. The basic structure of the decision tree is what is referred to as the template for a given application/protocol pair.

For a second application/protocol pair (i.e. App/protocol 2 in the lower part of FIG. 7), the generic structure of the decision tree is significantly different from the structure of the decision tree of App/protocol 1. However, for all flows using App/protocol 2 (Input set 2a, 2b, 2c), the generic relationship between network features and the MU can be described with one decision tree representation.

Once the generic relationships are learned and established (either by means of applying ML techniques or manually by experts in the field), the only task for the MUD controller is to determine the app/protocol pair of a flow or paired flows (a pair of UL and DL flows) and then to derive the specific values to fill the template.

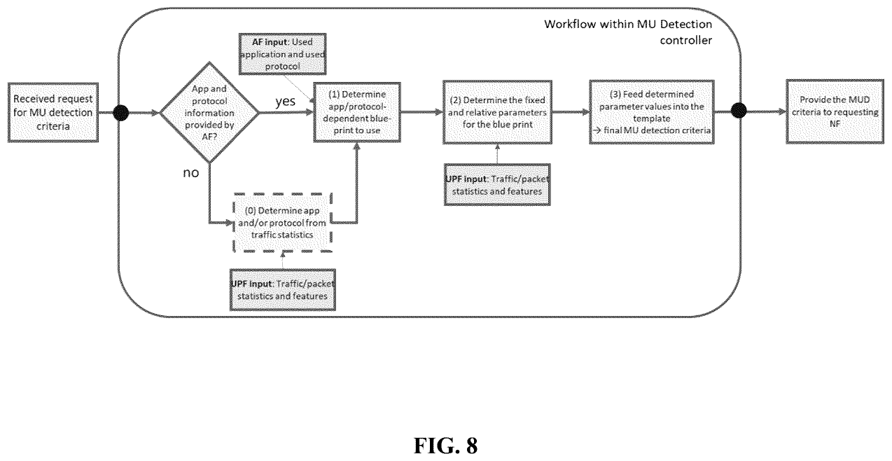

A workflow for the MUD controller to derive the values for the template is denoted in FIG. 8. The first step involves a request for a MUD criterion (e.g., by another NF), which is received by the MUD controller. There are two possible cases: (i) the AF provides the information about the app and protocol or (ii) the AF does not provide such additional information. In the latter case, the application and protocol information need to be determined based on traffic statistics that are provided by the UPF.

The workflow includes the following steps:
(1) The application/protocol combination determines the template to use (e.g., the decision tree representing the generic relationship between network features and MU information).
(2) Then, the specific values, which should be used together with the template are determined. These values are depending on the flow's network characteristics. The values can be fixed or relative (e.g., to network parameters such as the available bandwidth or the delay). The values are derived based on traffic/packet statistics obtained by the UPF.
(3) The derived values and the template are combined, which results in the final MUD criteria.

Finally, the MU detection criteria are provided to the requesting NF (e.g., the UPF), where it can be used to detect the MU information for the different packets and mark them accordingly.

In a particular embodiment, the MUD controller, i.e., the network entity shown in FIG. 3 or FIG. 4, is implemented in the NWDAF. The MUD controller can be realized as a new analytics ID, where the output is the MUD criteria which is provided to the consumer NF, e.g., the SMF.

During the training phase, it is determined how the MUD criteria can be derived later for a given flow. One example is, as outlined above, the usage of templates. These templates describe the generic relationships between traffic statistics and the MU for different application types.

While the training phase determines the template to use for specific applications/protocols, during the inference phase, the specific values to fill the template are determined. It may be understood that the inference phase can start without the training phase, in case the MUD controller gets the MU detection template from another network entity.

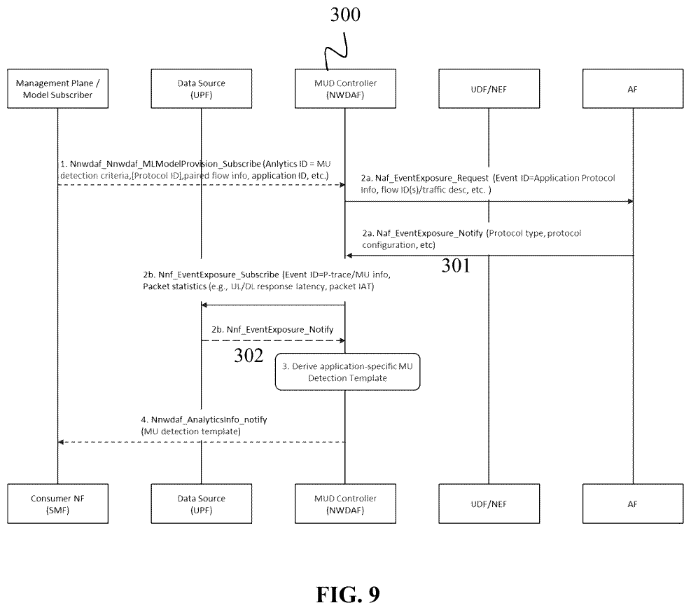

A procedure for the training phase is illustrated in FIG. 9. In particular, FIG. 9 shows NF interactions during the training phase when the MUD controller is within the NWDAF.

The steps are as follows:
1. The MUD controller is triggered by the management plane or a ML model (MU detection template) subscription request.
2. a. NWDAF collects protocol information, and other information from the AF (via NEF) with the Paired flow information. NWDAF may collect protocol information from the AF via UDR. Different procedures may be used and will not be illustrated here.
   b. NWDAF collected packet statistic information from SMF/UPF with the flow ID(s) (identified from the paired flow info), and P-trace/MU info for analytics accuracy improvement.
3. The NWDAF derives the application-specific MU detection template.
4. NWDAF (optional) notifies the MU detection template to the ML model consumer (if triggered by ML model subscription request in step 1)

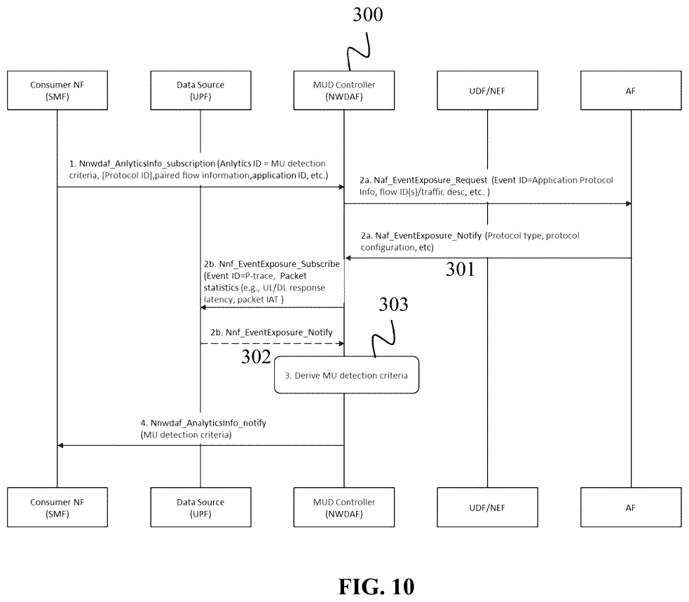

The procedure for inference when the MUD controller is implemented within the NWDAF is denoted in FIG. 10 and described in the following.
1. Consumer of analytics of MU detection criteria (e.g., SMF/UPF) subscribes to the service in NWDAF (with optional protocol ID if known, flow ID(s)).
2. a) NWDAF collects protocol information (such as protocol type/application configuration) from the AF (via NEF) with the flow ID(s)/traffic description. NWDAF may collect protocol info from the AF via UDR. Different procedures will be used and not illustrated here.
   b) NWDAF collected packet statistic information (UL/DL) from SMF/UPF with the flow ID(s), and optional P-trace/MU information for analytics accuracy improvement.
3. NWDAF derives the MU detection criteria.
4. NWDAF notifies MU detection criteria to the consumer NF (e.g., SMF).

Notably, the flow ID(s) may indicate a bidirectional QoS flow or two QoS flows for the UL and DL, which carry the application service traffic. The application/protocol configuration is as defined in Table 1 (e.g., frame rate, segment size). The protocol type may refer to for example RTP or HAS.

In another embodiment, the MUD controller, i.e., the network entity shown in FIG. 3 or FIG. 4, is part of the SMF.

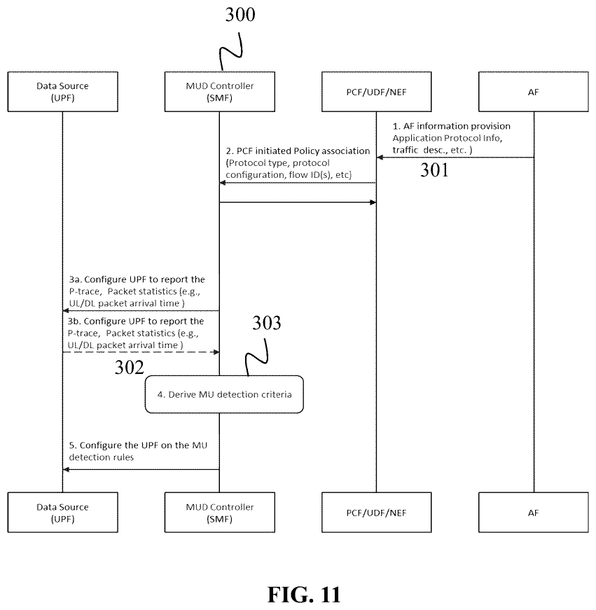

FIG. 11 shows a sequence diagram when the MUD controller is implemented in SMF.:
1. AF provides the protocol information, or additionally, traffic description, to PCF for a certain application/service using the AF QoS influence procedure, or via UDR using the service parameter provision procedure.
2. PCF determines MU level QoS treatment of a certain service flow, and indicates SMF to enable MU detection with Protocol information using policy association procedure.
3. a) SMF configures the UPF to report on the optional P-trace, Packet statistics of the correspondent flow.
   b) UPF reports the P-trace, packet statistic to the SMF of the correspondent flow.
4. SMF derives the MU detection criteria using ML
5. SMF configures the UPF on MU detection and marking rules based on MU detection criteria.

Concerning the Input and Output of the MUD Criteria, the MUD Controller can, for example, determine fixed values and/or relative values for the MUD Criteria. Fixed values may include for example the fixed size of specific packets such as an Intra-Frame-Request. Relative values may include the values that can be relative to the network characteristics (e.g., 0.9 times the RTT), characteristics of the application (e.g. 1*segment duration), or a combination of both application- and network-specific characteristics.

The relative and fixed values that are applied in the MUD criteria are derived by the MUD controller. The values depend on various characteristics, including the network characteristics of the UE's connection (such as available bandwidth, delay, packet loss rate, channel quality, etc.) and the application and protocol used as well as specific settings of the application and the protocol (e.g., the available video bitrates, the segment duration, etc.).

The MU detection outcome can be predictive or non-predictive. In particular, the outcome may be conclusions about a future number of packets (e.g. the next 100 packets belong to MU I-Frame), or the conclusion may only hold for a current packet. The MU detection outcome can be probabilistic, i.e., the MU detection criteria return a probability (e.g. packet belongs to an I-Frame with 80% confidence). The MU detection outcome can also be MU-only where the MU detection criteria only determine the start of a new MU (without specifying the type) or the MU is detected and additionally the MU-type is also detected.

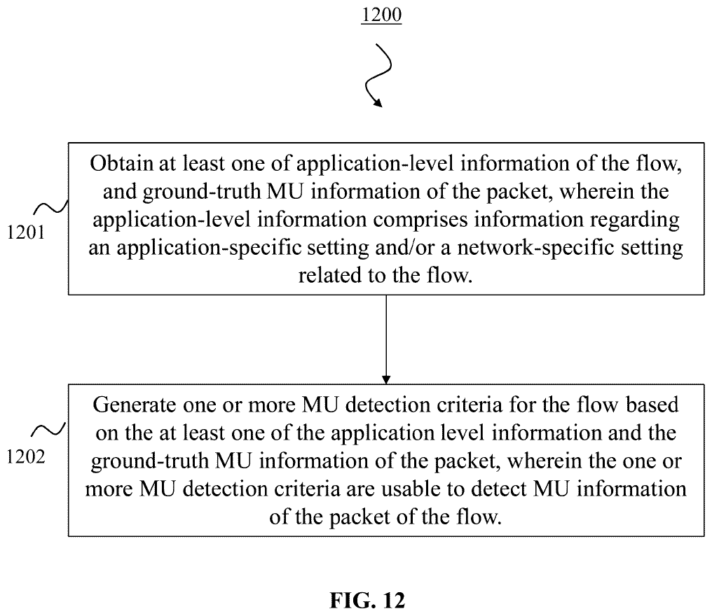

FIG. 12 shows a method 1200 according to an embodiment of the disclosure, particularly MU information detection of a packet in a flow. Notably, the flow comprises a plurality of packet sets, and each packet set comprises a MU that requires the same treatment in the network. In a particular embodiment, the method 1200 is performed by the network entity 300 shown in FIG. 3 or FIG. 4. The method 1200 comprises a step 1201 of obtaining at least one of application-level information 301 of the flow, and ground-truth MU information 302 of the packet, wherein the application-level information 301 comprises information regarding an application-specific setting and/or a network-specific setting related to the flow. The method 1200 further comprises a step 1202 of generating one or more MU detection criteria 303 for the flow based on the at least one of the application-level information 301 and the ground-truth MU information 302 of the packet, wherein the one or more MU detection criteria 303 are used for detecting MU information of packet of the flow.

To summarize, this disclosure provides a network entity that can make use of features combining UL and DL traffic statistics, thus exploiting knowledge of the UL/DL correlation of packets. UL/DL traffic correlation is a strong feature to conclude about the application behavior and consequently the transmitted MU. Hence, this results in an increase in the accuracy of MU detection.

This disclosure also provides the usage of information contained in the P-Trace and/or the RTP packet header. P-trace and RTP packet header can be used as the ground-truth for the ML model applied in the MUD Controller. This enables the MUD Controller to learn the relationship between traffic patterns and MU information.

This disclosure also provides adaptive usage of information provided via the AF. The MUD Criteria can be derived by the MUD Controller even in the absence of any additional information about the application. However, if (some) information is provided, it can be used to increase the MU detection accuracy and speed up the determination of the MUD Criteria.

In accordance with another embodiment, MUD Criteria (logic for deriving the MU) are provided as the output of the MUD Controller. MUD Criteria determined by the MUD Controller can run in another entity in the user plane (e.g. the UPF) to derive itself (without additional signaling with the control plane) the MU information.

Further, the provided MUD Criteria are parameterized. That is, one MUD Criterion may be used for several flows, as the parameters can be relative values. This reduces the signaling overhead between network entities utilizing the MUD Criteria (e.g. the UPF) and the MUD Controller (e.g., the SMF).

The present disclosure has been described in conjunction with various embodiments as examples as well as implementations. However, other variations can be understood and effected by those persons skilled in the art and practicing the claimed embodiments of the disclosure, from the studies of the drawings, this disclosure, and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutually different dependent claims does not indicate that a combination of these measures cannot be used in an advantageous implementation.

Furthermore, any method according to embodiments of the disclosure may be implemented in a computer program, having code means, which when run by processing means causes the processing means to execute the steps of the method. The computer program is included in a computer-readable medium of a computer program product. The computer-readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the network entity 300 comprises the communication capabilities in the form of e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, trellis-coded modulation (TCM) encoder, TCM decoder, power supply units, power feeders, communication interfaces, communication protocols, etc. which are suitably arranged together for performing the solution.

Especially, the processor(s) of the network entity 300 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

What is claimed is:

1. A network entity for media unit (MU) information detection of a packet in a flow, wherein the flow comprises a plurality of packet sets, and each packet set carries an MU that
requires a same treatment in a network, the network entity comprising at least one processor and being configured to:
obtain at least one of application-level information of the flow, and ground-truth MU information of the packet, wherein the application-level information of the flow comprises information regarding an application-specific setting and/or a network-specific setting related to the flow; and
generate one or more MU detection criteria for the flow based on the at least one of the application-level information of the flow and the ground-truth MU information of the packet, wherein the one or more MU detection criteria are usable to detect MU information of the packet of the flow.

2. The network entity according to claim 1, wherein the application-level information of the flow comprises at least one of the following:
an application identifier,
a packet filter set,
a used protocol type of the flow,
an application setting, and
pairing information of uplink and downlink traffic.

3. The network entity according to claim 1, wherein the ground-truth MU information of the packet comprises at least one of the following:
P-trace information, and
a header extension.

4. The network entity according to claim 1, wherein the application-level information of the flow is obtained from an application function.

5. The network entity according to claim 1, wherein the ground-truth MU information of the packet is obtained from a user plane function or an application function.

6. The network entity according to claim 1, wherein at least a part of the application-level information of the flow is further determined by the network entity by using a machine learning model.

7. The network entity according to claim 6, wherein the at least one processor is further configured to:
obtain traffic statistics related to the flow comprising uplink and downlink related packet statistics from the flow, or packet statistics of the flow and packet statistics of a corresponding uplink or downlink flow of that flow; and
determine the application-level information of the flow using the machine learning model using the traffic statistics as an input.

8. The network entity according to claim 7, wherein the traffic statistics related to the flow are obtained from a user plane function.

9. The network entity according to claim 1, wherein the at least one processor is further configured to:
obtain an MU detection template related to an application; and
derive the one or more MU detection criteria based on the MU detection template and the application-level information of the flow.

10. The network entity according to claim 9, wherein the MU detection template is obtained from an external network entity or generated by the network entity.

11. The network entity according to claim 9, wherein the MU detection template is represented by a decision tree, and the at least one processor of the network entity is further configured to:
derive one or more parameters for the decision tree using the application-level information; and
fill the decision tree with the one or more parameters to derive the one or more MU detection criteria.

12. The network entity according to claim 1, wherein the one or more MU detection criteria are parameterized for the application-specific setting and/or the network-specific setting.

13. The network entity according to claim 1, wherein the at least one processor is further configured to:
provide the one or more MU detection criteria directly or indirectly to a first network entity, for the first network entity to detect MU information of a packet.

14. The network entity according to claim 1, wherein the MU information of a packet comprises one or more of the following:
an indication of a start and/or end of the MU,
a type of the MU, a size of the MU, and
an importance of the MU.

15. The network entity according to claim 1, wherein the network entity is a controller and/or is implemented in a network data analytics function.

16. The network entity according to claim 15, wherein the at least one processor is further configured to:
obtain the application-level information of the flow from an application function via a network exposure function or a user data repository function, or from a session management function; and
notify the one or more MU detection criteria to a second network entity.

17. The network entity according to claim 1, wherein the network entity is a controller and/or is implemented in a session management function.

18. The network entity according to claim 13, wherein the at least one processor is configured to:
obtain the application-level information of the flow from an application function via a policy control function; and
notify the one or more MU detection criteria to the first network entity.

19. The network entity according to claim 8, wherein the at least one processor is further configured to:
obtain an indication from a policy control function, wherein the indication indicates the network entity to derive the one or more MU detection criteria;
configure a user plane function to provide the traffic statistics related to the flow to the network entity; and
configure the user plane function on MU detection based on the one or more MU detection criteria.

20. A method for media unit, MU, information detection of a packet in a flow, wherein the flow comprises a plurality of packet sets, and each packet set comprises an MU that requires a same treatment in a network, the method comprising:
obtaining at least one of application-level information of the flow, and ground-truth MU information of the packet, wherein the application-level information of the flow
comprises information regarding an application-specific setting and/or a network-specific setting related to the flow; and
generating one or more MU detection criteria for the flow based on the at least one of the application-level information of the flow and the ground-truth MU information of the packet, wherein the one or more MU detection criteria are used for detecting MU information of packet of the flow.
